(19) United States
(12) Patent Application Publication
(10) Pub. No.: US 2023/0411623 A1
(43) Pub. Date: Dec. 21, 2023

(54) ELECTRODE HAVING AN ALTERNATING LAYERED STRUCTURE

(71) Applicant: GM GLOBAL TECHNOLOGY OPERATIONS LLC, Detroit, MI (US)

(72) Inventors: Meixian WANG, Troy, MI (US); Nicole ELLISON, Southfield, MI (US); Xiaosong HUANG, Novi, MI (US); Raghunathan K, Troy, MI (US)

(73) Assignee: GM GLOBAL TECHNOLOGY OPERATIONS LLC, Detroit, MI (US)

(21) Appl. No.: 17/841,113

(22) Filed: Jun. 15, 2022

(51) Int. Cl. H01M 4/62; H01M 4/36; H01M 4/525; H01M 4/505; H01M 4/131

(52) U.S. Cl. CPC H01M 4/622; H01M 4/366; H01M 2004/021; H01M 4/505; H01M 4/131; H01M 4/525

(57) ABSTRACT

An electrode assembly for an electrochemical cell that cycles lithium ions is provided. The electrode includes a current collector, a binder material layer disposed on or near a surface of the current collector, and an electroactive material layer disposed on or near a surface of the binder material layer that faces away from the current collector. The electroactive material layer includes a plurality of electroactive material particles having an average specific surface area greater than or equal to about 1 m²/g to less than or equal to about 30 m²/g, and average particle size greater than or equal to about 0.1 micrometer to less than or equal to about 10 micrometers.

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes may include lithium manganese iron phosphate (LiMnFePO₄) (LMFP), or other positive electroactive materials, capable of high energy densities (e.g., about 700 Wh/L). These materials, however, often have properties, such as large specific surface areas and small particle sizes (e.g., D50 of less than or equal to about 1 μm), that present certain challenges, including, for example, delamination, particularly when incorporated in high amounts (e.g., greater than or equal to about 96 wt. %). Binders (e.g., greater than or equal to about 1 wt. %) are commonly incorporated to help prevent delamination. However, these cells often have high cell resistance and poor cell performance Accordingly, it would be desirable to develop improved electrode materials, and methods of making and using the same, that can address these challenges.

### SUMMARY

This section provides a general summary of the disclosure, and is not a comprehensive disclosure of its full scope or all of its features.

The present disclosure relates to high capacity electrodes for electrochemical cells. The electrodes include, for example, alternating electroactive material layers and high-conductive binder layers. The electroactive material layers may have high active material contents (e.g., greater than or equal to about 97 wt. %) and may include, for example, lithium manganese iron phosphate (LiMnₓFe₁₋ₓPO₄, where 0≤x≤1) (LMFP).

In various aspects, the present disclosure provides an electrode assembly for an electrochemical cell that cycles lithium ions. The electrode includes a current collector, a binder material layer disposed on or near a surface of the current collector, and an electroactive material layer disposed on or near a surface of the binder material layer that faces away from the current collector. The electroactive material layer may include a plurality of electroactive material particles having an average specific surface area greater than or equal to about 1 m²/g to less than or equal to about 30 m²/g, and average particle size greater than or equal to about 0.1 micrometer to less than or equal to about 10 micrometers.

In one aspect, the binder material layer may include greater than or equal to about 50 wt. % to less than or equal to about 90 wt. % of a binder material.

In one aspect, the binder material may be selected from the group consisting of: polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and combinations thereof.

In one aspect, the binder material layer may further include greater than or equal to about 5 wt. % to less than or equal to about 50 wt. % of a conductive additive.

In one aspect, the plurality of electroactive material particles may include electroactive material particles represented by LiMnₓFe₁₋ₓPO₄, where 0≤x≤1.

In one aspect, the electroactive material layer may further include greater than or equal to about 1 wt. % to less than or equal to about 5 wt. % of a conductive additive.

In one aspect, the electroactive material layer may further include greater than or equal to about 1 wt. % to less than or equal to about 5 wt. % of a binder material.

In one aspect, the binder layer may have an average thickness greater than or equal to about 1 micrometer to less than or equal to about 10 micrometers, and the electroactive material layer may have an average thickness greater than or equal to about 50 micrometers to less than or equal to about 300 micrometers.

In one aspect, the binder material layer may be a first binder material layer, the electroactive material layer may be a first electroactive material layer, and the electrode assembly may further include a second binder material layer disposed on or near a surface of the first electroactive material layer that faces away from the first binder material layer, and a second electroactive material layer disposed on or near a surface of the second binder material layer that faces away from the first electroactive material layer.

In various aspects, the present disclosure provides an electrode assembly for an electrochemical cell that cycles lithium ions. The electrode may include a current collector, a binder material layer disposed on or near a surface of the current collector, and an electroactive material layer disposed on or near a surface of the binder material layer that faces away from the current collector. The binder material layer includes a first amount of a first binder material. The electroactive material layer may include a plurality of electroactive material particles and a second amount of a second binder material that is less than the first amount. The plurality of electroactive material particles may have an average specific surface area greater than or equal to about 1 m²/g to less than or equal to about 30 m²/g, and an average particle size greater than or equal to about 0.1 micrometer to less than or equal to about 10 micrometers.

In one aspect, the first amount may be greater than or equal to about 50 wt. % to less than or equal to about 90 wt. %, and the second amount may be greater than or equal to about 1 wt. % to less than or equal to about 5 wt. %.

In one aspect, the binder material layer may further include greater than or equal to about 5 wt. % to less than or equal to about 50 wt. % of a conductive additive.

In one aspect, the plurality of electroactive material particles may include electroactive material particles represented by LiMnₓFe₁₋ₓPO₄, where 0≤x≤1.

In one aspect, the electroactive material layer may further include greater than or equal to about 1 wt. % to less than or equal to about 10 wt. % of a conductive additive.

In one aspect, the binder layer may have an average thickness greater than or equal to about 1 micrometer to less than or equal to about 10 micrometers, and the electroactive material layer may have an average thickness greater than or equal to about 50 micrometers to less than or equal to about 300 micrometers.

In one aspect, the binder material layer may be a first binder material layer, the electroactive material layer may be a first electroactive material layer, and the electrode assembly may further include a second binder material layer disposed on or near a surface of the first electroactive material layer that faces away from the first binder material layer, and a second electroactive material layer disposed on or near a surface of the second binder material layer that faces away from the first electroactive material layer.

In various aspects, the present disclosure provides an electrode assembly for an electrochemical cell that cycles lithium ions. The electrode may include a current collector and an electrode having an average thickness greater than or equal to about 50 micrometers to less than or equal to about 300 micrometers. The electrode may include a binder material layer disposed on or near a surface of the current collector, and an electroactive material layer disposed on or near a surface of the binder material layer that faces away from the current collector. The electroactive material layer may include LiMnₓFe₁₋ₓPO₄, where 0≤x≤1.

In one aspect, the binder material layer may include greater than or equal to about 50 wt. % to less than or equal to about 90 wt. % of a first binder material, and the electroactive material layer may include greater than or equal to about 1 wt. % to less than or equal to about 5 wt. % of a second binder material.

In one aspect, the binder material layer may further include greater than or equal to about 5 wt. % to less than or equal to about 50 wt. % of a first conductive additive, and the electroactive material layer may further include greater than or equal to about 1 wt. % to less than or equal to about 10 wt. % of a second conductive additive.

In one aspect, the binder material layer may be a first binder material layer, the electroactive material layer may be a first electroactive material layer, and the electrode assembly may further include a second binder material layer disposed on or near a surface of the first electroactive material layer that faces away from the first binder material layer, and a second electroactive material layer disposed on or near a surface of the second binder material layer that faces away from the first electroactive material layer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including electrodes having alternating electroactive material layers and high-conductive binder layers in accordance with various aspects of the present disclosure;

FIG. 2 is an illustration of an example electrode having alternating electroactive material layers and high-conductive binder layers in accordance with various aspects of the present disclosure;

FIG. 3 is an illustration of another example electrode having alternating electroactive material layers and high-conductive binder layers in accordance with various aspects of the present disclosure; and

FIG. 4 is a graphical illustration demonstrating cell performance of an example cell including an electrode having alternating electroactive material layers and high-conductive binder layers in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including electrodes having alternating electroactive material layers and high-conductive binder layers, and also, to methods of using and forming the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

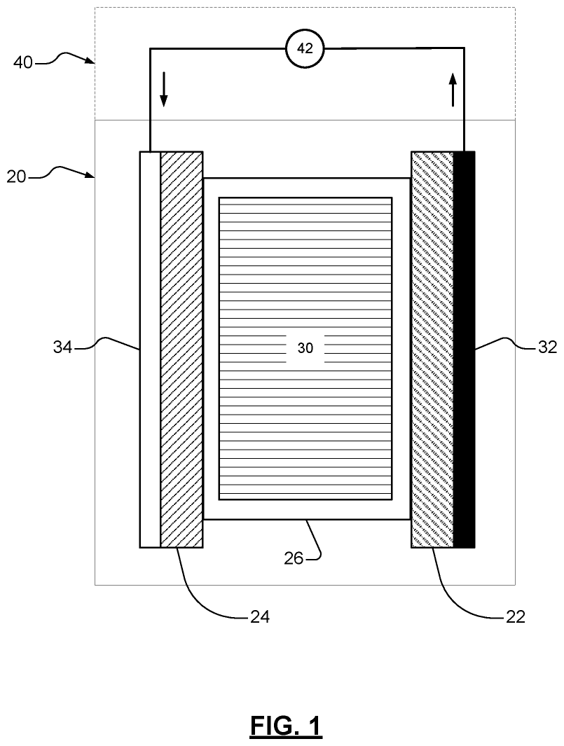

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second current collector 34 together with the positive electrode 24 may be referred to as a positive electrode assembly. The second electrode current collector 34 may be a metal foil, metal grid or screen, or expanded metal comprising aluminum or any other appropriate electrically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., >1 M) that includes a lithium salt dissolved in an organic solvent or a mixture of organic solvents.

Numerous conventional non-aqueous liquid electrolyte 30 solutions may be employed in the battery 20. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) layer and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂ (PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte layer may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have an average thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). For example, in certain variations, the negative electrode 22 may include a carbonaceous-silicon based composite including, for example, about or exactly 10 wt. % of a silicon-based electroactive material and about or exactly 90 wt. % graphite.

In certain variations, the negative electroactive material may be optionally intermingled (e.g., slurry casted) with an electronically conductive material (i.e. conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

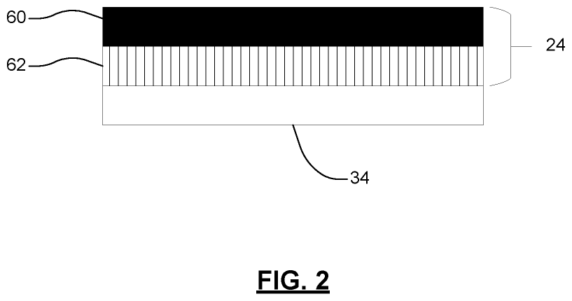

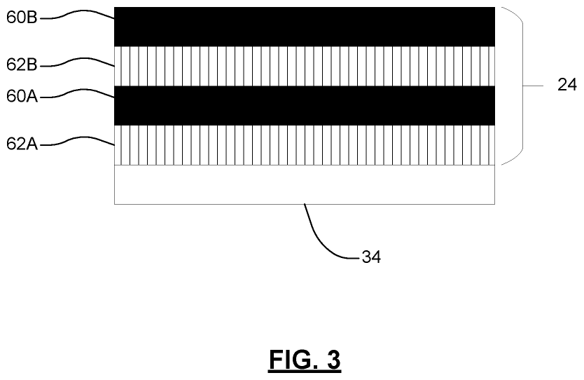

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. For example, in certain variations, the positive electrode 24 may include one or more alternating layers of a positive electroactive material (defining electroactive material layers 60, 60A, 60B) and a high-conductive binder material (defining high-conductive binder layers 62, 62A, 62B). For example, as illustrated in FIG. 2, the positive electrode 24 may include a positive electroactive material layer 60 and a high-conductive binder material layer 62 disposed between the positive electroactive material layer 60 and the positive electrode current collector 34. In other variations, as illustrated in FIG. 3, the positive electrode 24 may include a first binder material layer 62A disposed between the positive electrode current collector 34 and a first positive electroactive material layer 60A, and a second binder material layer 62B disposed between the first positive electroactive material layer 60A and a second positive electroactive material layer 60B.

Although only two examples are illustrated, it should be appreciated that, in other variations, the positive electrode 24 may include fewer or more positive electroactive material layers 60, 60A, 60B and/or high-conductive binder layers 62, 62A, 62B. A total number of positive electroactive material layers 60, 60A, 60B may be the same as or different from a total number of high-conductive binder layers 62, 62A, 62B. In each instance, however, a high-conductive binder layer 62, 62A, 62B is disposed adjacent to the positive electrode current collector 34.

The high-conductive binder layers 62, 62A, 62B each include a binder material like that optionally incorporated into the negative electrode 22. For example, the high-conductive binder layers 62, 62A, 62B may include a binder material selected from the group consisting of: polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and combinations thereof. The binder materials defining the high-conductive binder layers 62, 62A, 62B may be the same as or different form the binder material(s) optionally included in the negative electrode 22. Further, the (first) binder material of the first high-conductive binder layer 62A may be the same as or different from the (second) binder material of the second high-conductive binder layer 62B. In each instance, the high-conductive binder layers 62, 62A, 62B is free of an electroactive material.

In certain variations, the binder material of the one or more of the high-conductive binder layers 62, 62A, 62B may be optionally intermingled (e.g., slurry casted) with a (first) conductive additive. For example, the high-conductive binder layers 62, 62A, 62B may include greater than or equal to about 50 wt. % to less than or equal to about 90 wt. % of the binder material; and greater than or equal to about 0 wt. % to less than or equal to about 50 wt. %, optionally greater than or equal to about 5 wt. % to less than or equal to about 50 wt. %, and in certain aspects, optionally greater than or equal to about 10 wt. % to less than or equal to about 50 wt. %, of the conductive additive. The conductive additive may be selected form single-wall carbon nanotubes (SWCNTs), graphene, multi-wall carbon nanotubes (MWCNTs), highly graphitized carbon fiber, and/or other nano-carbon based high-conductive fillers. The (first) conductive additive of the first high-conductive binder layer 62A may be the same as or different from the second high-conductive binder layer 62B.

Each of the positive electroactive material layers 60, 60A, 60B includes a plurality of positive electroactive material particles having high specific surface areas and small particle sizes. The positive electroactive material particles may have an average specific surface area greater than or equal to about 1 m²/g to less than or equal to about 30 m²/g, optionally greater than or equal to about 2 m²/g to less than or equal to about 30 m²/g, optionally greater than or equal to about 3 m²/g to less than or equal to about 30 m²/g, optionally greater than or equal to about 4 m²/g to less than or equal to about 30 m²/g, greater than or equal to about 5 m²/g to less than or equal to about 30 m²/g, and in certain aspects, optionally greater than or equal to about 10 m²/g to less than or equal to about 20 m²/g; and an average particle size greater than or equal to about 0.1 μm to less than or equal to about 10 μm, and in certain aspects, optionally greater than or equal to about 1 μm to less than or equal to about 5. For example, in certain variations, the positive electroactive material particles may include lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, and/or LiMn_{0.75}Fe_{0.25}PO₄.

In other variations, one or more of the positive electroactive material layers 60, 60A, 60B may be composite layers. For example, one of the positive electroactive material layers 60, 60A, 60B may include a first plurality of positive electroactive material particles and a second plurality of positive electroactive material particles. The first plurality of positive electroactive material particles may include particles having high specific surface areas and small particle sizes, like lithium manganese iron phosphates (LiMnₓFe₁₋ₓPO₄, where 0≤x≤1) (LMFP); and the second plurality of positive electroactive material particles may include, for example, a layered oxide represented by LiMeO₂, where Me is a transition metal, such as cobalt (Co), nickel (Ni), manganese (Mn), iron (Fe), aluminum (Al), vanadium (V), or combinations thereof; an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO4)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; and/or a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In certain variations, the positive electroactive material of one or more of the positive electroactive material layers 60, 60A, 60B may be optionally intermingled (e.g., slurry casted) with an electronically conductive material that provide an electron conductive path and/or a polymeric binder material that improve the structural integrity of the positive electroactive material layer 60, 60A, 60B. For example, the positive electroactive material layers 60, 60A, 60B greater than or equal to about 90 wt. % to less than or equal to about 99 wt. %, and in certain aspects, optionally greater than or equal to about 95 wt. % to less than or equal to about 97 wt. %, of positive electroactive material; greater than or equal to about 1 wt. % to less than or equal to about 5 wt. %, and in certain aspects, optionally greater than or equal to about 1.5 wt. % to less than or equal to about 2 wt. %, of the binder material; and greater than or equal to about 1 wt. % to less than or equal to about 5 wt. %, and in certain aspects, optionally greater than or equal to about 1.5 wt. % to less than or equal to about 2 wt. %, of the conductive material. The binder material and/or conductive material as disposed in the positive electroactive material layers 60, 60A, 60B may be the same or different form the binder material and/or conductive material as disposed in the high-conductive binder layers 62, 62A, 62B. In each instance, however, the high-conductive binder layers 62, 62A, 62B have first amounts of binder material that are greater than second amounts of binder material as included in the positive electroactive material layers 60, 60A, 60B.

The high-conductive binder layers 62, 62A, 62B may have average thicknesses greater than or equal to about 1 μm to less than or equal to about 10 μm, and in certain aspects, optionally greater than or equal to about 1 μm to less than or equal to about 5 μm; the positive electroactive material layers 60, 60A, 60B may have average thicknesses greater than or equal to about 50 μm to less than or equal to about 300 μm, and in certain aspects, optionally greater than or equal to about 150 μm to less than or equal to about 200 μm; and the positive electrode 24 may have an average thickness greater than or equal to about 50 μm to less than or equal to about 300 μm, and in certain aspects, optionally greater than or equal to about 150 μm to less than or equal to about 200 μm. As in the instance of the negative electrode 22, the electrolyte 30 may be introduced into the positive electrode 24, for example after cell assembly, and contained within pores of the positive electrode 24. In certain variations, the positive electrode 24 (including the one or more high-conductive binder layers 62, 62A, 62B and the one or more positive electroactive material layers 60, 60A, 60B) may include a plurality of solid-state electrolyte particles.

In various aspects, the present disclosure provides methods for forming a positive electrode including one or more high-conductive binder layers and one or more positive electroactive material layers, like the positive electrode 24 illustrated in FIGS. 1-3. In certain variations, the one or more high-conductive binder layers and the one or more positive electroactive material layers may be coated simultaneously onto or near a surface of a current collector. In other variations, the positive electrode may be prepared using a consecutive approach, where a first high-conductive binder layer is disposed onto or near a surface of the current collector, a first positive electroactive material layer is disposed onto or near an exposed surface of the first high-conductive binder layer, and the process continues until a positive electrode is formed having the desired layered structure (for example, a second high-conductive binder layer may be disposed onto or near an exposed surface of the first positive electroactive material layer, and a second positive electroactive material layer may be disposed onto or near an exposed surface of the second high-conductive layer). In certain variations, the high-conductive binder layers and/or the positive electroactive material layers may be disposed using common industrial coating processes, such as slot-die coating and/or reverse-comma coating.

In certain variations, slurries may be prepared, disposed, and dried to form the respective high-conductive binder layers and/or the positive electroactive material layers. For example, in certain variations, a precursor slurry may be prepared for the high-conductive binder layers. Example slurries may include greater than or equal to about 1 wt. % to less than or equal to about 10 wt. %, and in certain aspects, optionally greater than or equal to about 2 wt. % to less than or equal to about 5 wt. %, of a binder material; greater than or equal to about 0.1 wt. % to less than or equal to about 1 wt. %, and in certain aspects, optionally greater than or equal to about 0.1 wt. % to less than or equal to about 0.5 wt. %, of a conductive additive; and greater than or equal to about 50 wt. % to less than or equal to about 95 wt. %, and in certain aspects, optionally greater than or equal to about 90 wt. % to less than or equal to about 95 wt. %, of a solvent. The solvent may include N-methyl-2-pyrrolidone (NMP), dimethylformamide (DMF); dimethyl sulfoxide (DMSO), cyrene, dihydrolevoglucosenone, and combinations and the like. In certain variations, by way of example only, the high-conductive binder layers 62, 62A, 62B may include about 0.4 wt. % of single-walled carbon nanotubes, about 2 wt. % of polyvinylidene fluoride (PVdF), and about 97.6 wt. % of N-methyl-2-pyrrolidone (NMP).

Certain features of the current technology are further illustrated in the following non-limiting examples.

### EXAMPLE 1

Example batteries and battery cells may be prepared in accordance with various aspects of the present disclosure. An example cell 410 may include a positive electrode including a positive electroactive material layer disposed near or onto a positive electrode current collector and a high-conductive binder layer disposed between the positive electrode current collector and the positive electroactive material layer, for example, as illustrated in FIG. 2. The high-conductive binder layer may include, for example, about 85 wt. % or more of a first (binder material) (e.g., polyvinylidene fluoride (PVdF)) and about 15 wt. % of a (first) conductive additive (e.g., single-wall carbon nanotube). The positive electroactive material layer may include about 97 wt. % of one or more lithium manganese iron phosphates (LiMnₓFe₁₋ₓPO₄, where 0≤x≤1) (LMFP), about 1.5 wt. % of a (second) binder material (e.g., polyvinylidene fluoride (PVdF)), and about 1.5 wt. % of a (second) conductive additive (e.g., SuperP). A comparative cell 420 may include a positive electroactive material layer having about 92 wt. % of one or more lithium manganese iron phosphates (LiMnₓFe₁₋ₓPO₄, where 0≤x≤1) (LMFP), about 5 wt. % of a (third) binder material (e.g., polyvinylidene fluoride (PVdF)), and about 3 wt. % of a (third) conductive additive (e.g., SuperP). The comparative cell 420 does not include a high-conductive binder layer. The example cell 410 and the comparative cell 420 may both have a positive electrode loading of about 5 mAh/cm².

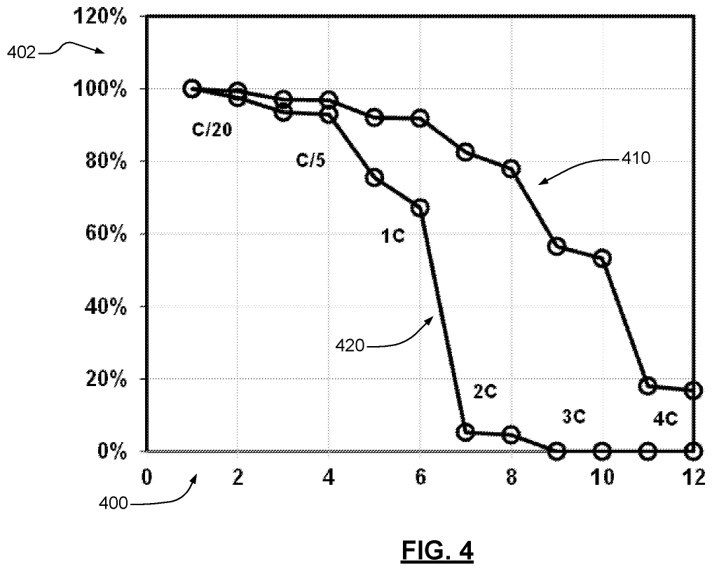

FIG. 4 is a graphical illustration demonstrating the cell discharge performance at various currents of the example cell 410, as compared to the comparative cell 420, where the x-axis 400 represents cycle number, and the y-axis 402 represents normalized capacity (%). As illustrated, the example cell 410 has improved cell discharge performance. For example, at 2 C the example cell including the high-conductive binder layer retains about 80% of the capacity at C/20, while the comparative cell 420 without a high-conductive binder layer retains less than about 10% of the capacity at C/20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode assembly for an electrochemical cell that cycles lithium ions, the electrode comprising:
a current collector;
a binder material layer disposed on or near a surface of the current collector; and
an electroactive material layer disposed on or near a surface of the binder material layer that faces away from the current collector, the electroactive material layer comprising a plurality of electroactive material particles having an average specific surface area greater than or equal to about 1 m²/g to less than or equal to about 30 m²/g, and average particle size greater than or equal to about 0.1 micrometer to less than or equal to about 10 micrometers.

2. The electrode assembly of claim 1, wherein the binder material layer comprises greater than or equal to about 50 wt. % to less than or equal to about 90 wt. % of a binder material.

3. The electrode assembly of claim 2, wherein the binder material is selected from the group consisting of: polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and combinations thereof.

4. The electrode assembly of claim 1, wherein the binder material layer further comprises greater than or equal to about 5 wt. % to less than or equal to about wt. % of a conductive additive.

5. The electrode assembly of claim 1, wherein the plurality of electroactive material particles comprise electroactive material particles represented by LiMnₓFe₁₋ₓPO₄, where 0≤x≤1.

6. The electrode assembly of claim 1, wherein the electroactive material layer further comprises greater than or equal to about 1 wt. % to less than or equal to about 5 wt. % of a conductive additive.

7. The electrode assembly of claim 1, wherein the electroactive material layer further comprises greater than or equal to about 1 wt. % to less than or equal to about 5 wt. % of a binder material.

8. The electrode assembly of claim 1, wherein the binder layer has an average thickness greater than or equal to about 1 micrometer to less than or equal to about 10 micrometers, and the electroactive material layer has an average thickness greater than or equal to about 50 micrometers to less than or equal to about 300 micrometers.

9. The electrode assembly of claim 1, wherein the binder material layer is a first binder material layer, the electroactive material layer is a first electroactive material layer, and the electrode assembly further comprises:
a second binder material layer disposed on or near a surface of the first electroactive material layer that faces away from the first binder material layer; and
a second electroactive material layer disposed on or near a surface of the second binder material layer that faces away from the first electroactive material layer.

10. An electrode assembly for an electrochemical cell that cycles lithium ions, the electrode comprising:
a current collector;
a binder material layer disposed on or near a surface of the current collector and comprising a first amount of a first binder material; and
an electroactive material layer disposed on or near a surface of the binder material layer that faces away from the current collector, the electroactive material layer comprising a plurality of electroactive material particles and a second amount of a second binder material that is less than the first amount, the plurality of electroactive material particles having an average specific surface area greater than or equal to about 1 m²/g to less than or equal to about 30 m²/g, and an average particle size greater than or equal to about 0.1 micrometer to less than or equal to about 10 micrometers.

11. The electrode assembly of claim 10, wherein the first amount is greater than or equal to about 50 wt. % to less than or equal to about 90 wt. %, the second amount is greater than or equal to about 1 wt. % to less than or equal to about 5 wt. %.

12. The electrode assembly of claim 10, wherein the binder material layer further comprises greater than or equal to about 5 wt. % to less than or equal to about 50 wt. % of a conductive additive.

13. The electrode assembly of claim 10, wherein the plurality of electroactive material particles comprise electroactive material particles represented by LiMnₓFe₁₋ₓPO₄, where 0≤x≤1.

14. The electrode assembly of claim 10, wherein the electroactive material layer further comprises greater than or equal to about 1 wt. % to less than or equal to about 10 wt. % of a conductive additive.

15. The electrode assembly of claim 10, wherein the binder layer has an average thickness greater than or equal to about 1 micrometer to less than or equal to about 10 micrometers, and the electroactive material layer has an average thickness greater than or equal to about 50 micrometers to less than or equal to about 300 micrometers.

16. The electrode assembly of claim 10, wherein the binder material layer is a first binder material layer, the electroactive material layer is a first electroactive material layer, and the electrode assembly further comprises:
a second binder material layer disposed on or near a surface of the first electroactive material layer that faces away from the first binder material layer; and
a second electroactive material layer disposed on or near a surface of the second binder material layer that faces away from the first electroactive material layer.

17. An electrode assembly for an electrochemical cell that cycles lithium ions, the electrode comprising:
a current collector; and
an electrode having an average thickness greater than or equal to about 50 micrometers to less than or equal to about 300 micrometers and comprising:
a binder material layer disposed on or near a surface of the current collector; and
an electroactive material layer disposed on or near a surface of the binder material layer that faces away from the current collector, the electroactive material layer comprising LiMnₓFe₁₋ₓPO₄, where 0≤x≤1.

18. The electrode assembly of claim 17, wherein the binder material layer comprises greater than or equal to about 50 wt. % to less than or equal to about 90 wt. % of a first binder material, and the electroactive material layer comprises greater than or equal to about 1 wt. % to less than or equal to about 5 wt. % of a second binder material.

19. The electrode assembly of claim 17, wherein the binder material layer further comprises greater than or equal to about 5 wt. % to less than or equal to about 50 wt. % of a first conductive additive, and the electroactive material layer further comprises greater than or equal to about 1 wt. % to less than or equal to about 10 wt. % of a second conductive additive.

20. The electrode assembly of claim 17, wherein the binder material layer is a first binder material layer, the electroactive material layer is a first electroactive material layer, and the electrode assembly further comprises:
a second binder material layer disposed on or near a surface of the first electroactive material layer that faces away from the first binder material layer; and a second electroactive material layer disposed on or near a surface of the second binder material layer that faces away from the first electroactive material layer.
